(19) United States
(12) Patent Application Publication
(10) Pub. No.: US 2020/0137195 A1
(43) Pub. Date: Apr. 30, 2020

(54) TECHNIQUES AND ARCHITECTURES FOR MANAGING OPERATION FLOW IN A COMPLEX COMPUTING ENVIRONMENT

(71) Applicant: salesforce.com, inc., San Francisco, CA (US)

(72) Inventors: Nathan Edward Lipke, Denver, CO (US); William Charles Eidson, Palo Alto, CA (US); Catherine Schell, San Francisco, CA (US); Samuel William Bailey, Cardiff (GB); James Johnson, San Francisco, CA (US); Yucheng Wang, San Francisco, CA (US); Anvitha Jaishankar, San Francisco, CA (US); Jason Teller, San Bruno, CA (US)

(21) Appl. No.: 16/177,352

(22) Filed: Oct. 31, 2018

(51) Int. Cl. H04L 29/08; G06F 9/451; G06F 17/30; G06F 3/0484; G06F 3/0483

(52) U.S. Cl. CPC H04L 67/36; G06F 9/451; G06F 3/0483; G06F 3/04847; G06F 3/04845; G06F 17/3056

(57) ABSTRACT

Techniques and mechanisms to manage a flow of operations. Operation tracking screens are presented on a display. At least some of a first screen area has one or more graphical control elements configured to receive information associated with actions corresponding to the sequence of operations. The actions include at least a first action performed concurrently with a second action. A second screen area has a graphical representation of stages of the sequence of operations in response to an initiation of the application to process the sequence of operations. The graphical representation of the stages is modified to include a graphical representation of a modification to the stages. The modification comprises a modification to multiple stages concurrently. Signals associated with the information associated with the actions associated with the sequence of operations are received. The sequence of operations to be processed.

### TECHNICAL FIELD

Embodiments relate to techniques for managing configurable sequences of operations within a complex environment. More particularly, embodiments relate to techniques for more accurately monitoring and flagging service disruptions within a multi-server environment utilizing a single database node.

### BACKGROUND

As computing architectures and operating environments become more complex and provide more functionality, the sophistication required by a user to fully utilize available resources and functionality increases. In many cases, an insufficient number of trained programmers/administrators are available and typical users lack the skills and tools to fully utilize the resources and functionality available. Thus, current tools and environments do not maximize available functionality.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1 is one embodiment of an environment in which an application can process a sequence of operations that can be managed according to the techniques and architecture described herein.

FIG. 2 is one embodiment of an operation tracking design interface.

FIG. 3 illustrates a block diagram of an environment where an on-demand database service might be used.

FIG. 4 illustrates a block diagram of another environment where an on-demand database service might be used.

### DETAILED DESCRIPTION

In the following description, numerous specific details are set forth. However, embodiments of the invention may be practiced without these specific details. In other instances, well-known structures and techniques have not been shown in detail in order not to obscure the understanding of this description.

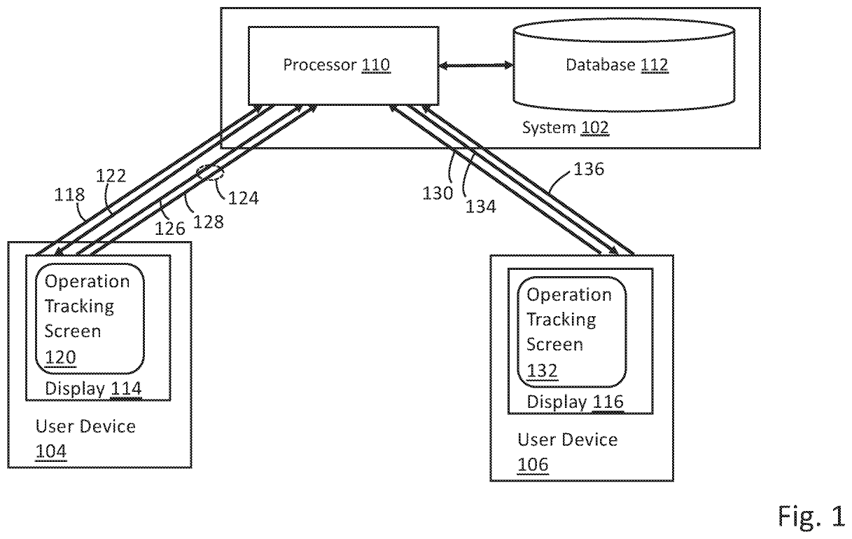

FIG. 1 is one embodiment of an environment in which an application can process a sequence of operations that can be managed according to the techniques and architecture described herein. Environment 100 can include, for example, system 102, user device 104, and user device 106. Alternatively, one or more functions of user device 106 and one or more functions of user device 104 can be incorporated into user device 108. System 102 can include, for example, processor 110 and database 112. User device 104 can include, for example, display 114. User device 106 can include, for example, display 116.

In one embodiment, processor 110 can be configured to receive signal 118 to initiate a production of a first application to process a first sequence of operations. For example, processor 110 can receive signal 118 from user device 104.

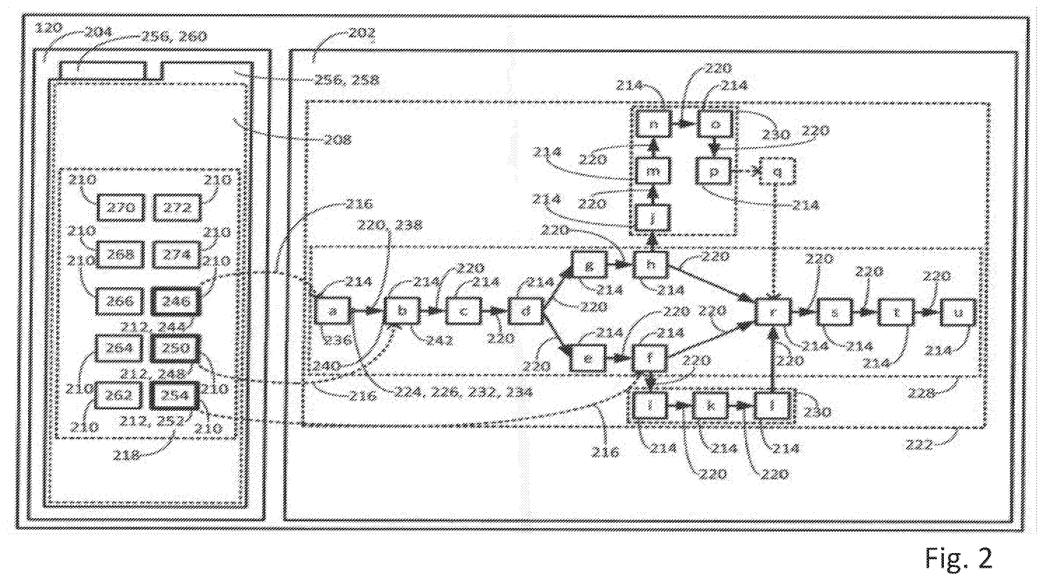

In one embodiment, processor 110 can be configured to cause, in response to a receipt of signal 118, operation tracking design screen 120 to be presented 122 on display 114. FIG. 2 is one embodiment of an operation tracking design interface. Operation tracking design screen 120 can include, for example, screen area 202 and screen area 204. In one embodiment, screen area 204 can include population 208 of graphical control elements 210 configured to cause, in response to being selected 212, graphical representations 214 to appear 216 in screen area 202.

With reference to FIGS. 1 and 2, processor 110 can be configured to receive signals 124 from user device 104. Signals 124 can, for example, indicate selections 212, from population 208, of set 218 of graphical control elements 210. In the example of FIG. 2, eight graphical control elements 210 included in population 208 are also included in set 210. For simplicity, only three selections 212 are illustrated. Set 218 of graphical control elements 210 can be associated with actions associated with the first sequence of operations. Second signals 124 can also indicate directions 220, with respect to set 222 of graphical representations 214, among the actions associated with the first sequence of operations.

In one embodiment, processor 110 can be configured to cause, in response to receipt of signals 124, a set of operation tracking screens to be produced. At least some of the screen areas can have additional graphic control elements configured to receive information associated with the actions associated with the first sequence of operations. The actions can include, for example, an action performed concurrently with a second action. The additional screen areas can have a graphical representation of stages of the first sequence of operations. The graphical representation of the stages can be of a default sequence of the stages in response to an initiation of the first application to process the first sequence of operations. The graphical representation of the stages can be modified to include a graphical representation of an additional stage in response to a determination of a result of a specific condition being a specific value.

Various techniques and architectures for managing the graphical representation of the stages is described in greater detail below. With reference to FIGS. 1 and 2, in various embodiments, signals 124 can include, for example, signals 126 and signals 128. The signals 126 can indicate selections 212 of set 218 of graphical control elements 210. Signals 128 can indicate directions 220, with respect to set 222 of graphical representations 214, among the actions associated with the first sequence of operations.

In various embodiments, processor 110 can be configured to cause a set of operation tracking screens to be produced by: (1) causing, in response to receipt of signals 126, set 222 of graphical representations 214, associated with set 218 of graphical control elements 210, to appear 216 in screen area 202 and (2) causing, in response to receipts of signals 128, set 224 of graphical representations 226 to appear in screen area 202. In some embodiments, set 224 of graphical representations 226 can indicate directions 220, with respect to set 222 of graphical representations 214, among the actions associated with the first sequence of operations.

In the example of FIG. 2, twenty-one directions (220) are illustrated; however, for simplicity, only one of the twenty-one directions is illustrated to be a graphical representation (226) of the set (224). In one embodiment, conjunction with selection 212 of graphical control element 210, a determination can be made whether the graphical control element 210 is associated with an action in a stage in a default sequence of stages 228 or whether graphical control element 210 is associated with an action in additional stage 230.

In various embodiments, processor 110 can be configured to cause set 224 of graphical representations 226 to appear in the screen area 202 by: (1) causing graphical representation 232, of set 224 of graphical representations 226, to appear in first screen area 202 at location 234 of graphical representation 236 of set 222 of graphical representations 214 and (2) causing pointing device gesture 238 to occur to move graphical representation 232 to appear in screen area 202 at location 240 of graphical representation 242 of set 222 of graphical representations 214 (e.g., a drag and drop pointing device gesture).

In FIG. 2, twenty-one directions (220) are illustrated; however, for simplicity, only one of the twenty-one directions is illustrated to be graphical representation 226 of set 224. This is graphical representation 232. For simplicity, only one graphical representation 236, only one graphical representation 242, and only one pointing device gesture 238 from location 234 to location 240 are illustrated.

In various embodiments, the actions associated with the first sequence of operations can further include, for example, actions causing the stages of the first sequence of operations to be defined and/or actions causing the operation tracking screens to be presented on display 116 and/or an action being determining the result of the specific condition. In some embodiments, display 116 can be display 114. For example, the function of user device 106 and the function of user device 104 can be incorporated into user device 108.

In various embodiments, signals 124 can indicate selections 244 of type 246 of graphical control elements 210. Type 246 can be associated with an action to change a value of a specific variable. The specific variable can be referenceable by another action. Signals 124 can select the specific variable to be a stage. The stage can be of the first sequence of operations. Signals 124 can set the value to be a name of the stage. Signals 124 can indicate selections 248 of type 250 of graphical control elements 210. Type 250 can be associated with an action to present an operation tracking screen. Signals 124 can indicate selection 252 of type 254 of the graphical control elements 210. Type 254 can be associated with an action to determine a result of a condition. Signals 124 can set the condition to be the specific condition.

In some embodiments, set 218 of graphical control elements 210 can include type 246. In one embodiment, screen area 204 can include tab interface 256. Tab interface 256 can include, for example, tab 258 and tab 260. Tab 258 can include population 208 of graphical control elements 210.

With reference to FIGS. 1 and 2, in various embodiments, set 218 of graphical control elements 210 can include type 262 of first graphical control elements 210 associated with an action to initiate a second application to process a second sequence of operations. The second sequence of operations can be associated with a second set of operation tracking screens (not illustrated). The actions associated with the second sequence of operations can include an action to interface with database 112 (i.e., the same database with which the first sequence of operations can interact).

In some embodiments, the actions associated with the first sequence of operations can further include, for example, one or more of an action causing a value to be read from database 112, an action causing a value to be written to database 112, an action causing a record to be created in database 112, an action causing a record to be deleted from database 112, an action causing one or more specific actions to be performed, in an iterative manner, on each item in a set of items, and/or an action causing processing of at least a portion of the first sequence of operations to pause until a specific event occurs.

Returning to FIG. 1, processor 110 can be configured to receive signal 130 to initiate the first application to process the first sequence of operations. For example, processor 110 can receive signal 130 from user device 106. In one embodiment, user device 106 can be user device 104. For example, the function of user device 106 and the function of user device 104 can be incorporated into user device 108. Processor 110 can be configured to cause, in response to a receipt of signal 130, operation tracking screen 132 to be presented 134 on display 116.

In some embodiments, processor 110 can be configured to receive one or more of signals 136 associated with the information as a free-form text. Processor 110 can be configured to cause the first sequence of operations to be processed by at least producing, through a word embedding process, a vector that represents one or more words of the free-form text. Alternatively, or additionally, another artificial intelligence technique can be used to convert the free-form text into information that can be processed in the first sequence of operations.

For illustrative purposes herein, the first sequence of operations can be for a verification of information for a policy for car insurance for a family. In the example, the family can be the Browns: Dad, Mom, Daughter, and Grandma. In the example, the policy previously covered Dad, Mom, and Daughter, but, at the time of the verification, Daughter can be removed from the policy and Grandma can be added to the policy.

With reference to FIGS. 1 and 2, processor 110 can receive, from user device 104, signal 118 to initiate the production of the first application to process the first sequence of operations. Processor 110 can cause, in response to the receipt of signal 118, operation tracking design screen 120 to be presented 122 on display 114. Processor 110 can receive, from user device 104, signals 124. Signals 124 can indicate selections 212, from population 208, of set 218 of graphical control elements 210.

In various embodiments, selections 212 can include: (1) four selections 212 of type 246 of first graphical control elements 210 to cause graphical representations 214 for defining a first stage (a), a second stage (i), a third stage (j), and a fourth stage (s); (2) five selections 212 of type 250 of graphical control elements 210 to cause graphical representations 214 for a first operation tracking screen (a), a second operation tracking screen (d), a third operation tracking screen (k), a fourth operation tracking screen (n), and a fifth operation tracking screen (u); (3) two selections 212 of type 254 of graphical control elements 210 to cause graphical representations 214 for a first determination of a result of a condition (f) and a second determination of a result of a condition (h); (4) a selection of type 262 of graphical control elements 210 to cause the graphical representation 214 for an initiation of a second application to process a second sequence of operations; (5) two selections of type 264 of graphical control elements 210 to cause graphical representations 214 for one or more first values to be read from database 112 (c) and one or more second values to be read from database 112 (t); (6) a selection of type 266 of graphical control elements 210 to cause graphical representation 214 for one or more values to be written to database 112 (o); (7) a selection of type 268 of graphical control elements 210 to cause graphical representation 214 for one or more records to be created in database 112 (m); (8) a selection of type 270 of the graphical control elements 210 to cause graphical representation 214 for one or more records to be deleted from database 112 (l); (9) two selections of type 272 of graphical control elements 210 to cause graphical representations 214 for a first one or more specific actions to be performed, in an iterative manner, on each item in a first set of items (e) and a second one or more specific actions to be performed, in an iterative manner, on each item in a second set of items (g); and (10) a selection of type 274 of graphical control elements 210 to cause graphical representation 214 for causing processing of at least a portion of the first sequence of operations to pause until a specific event occurs (r).

Signals 124 can also indicate directions 220, with respect to set 222 of graphical representations 214, among the actions associated with the first sequence of operations as illustrated in FIG. 2. Processor 110 can cause, in response to the receipts of signals 124, the first set of operation tracking screens to be produced.

The processor can receive, from user device 106, signal 130 to initiate the first application to process the first sequence of operations. In response to an initiation of the first application, an action associated with graphical representations 214 (a) defines the first stage (Verify People Covered by Policy). Processor 110 can cause, in response to the receipt of signal 130, the first set of operation tracking screens to be presented 134 on display 116 as an action associated with graphical representations 214 (b).

In various embodiments, more complex operators can be supported to allow more efficient manipulation of the stages. For example, an “Equals” operator can function to replace a collection of stages that are equal to a specified characteristic (e.g., operator type). As another example, an “Add” operator can function to add stages to the end of a collection of stages. The “Add” operator can also function to insert one or more stages at a specified location in the flow of stages.

Further complex operators can include, for example, a “Subtract” operator that can function to remove an element equal to a specified value (e.g., stage 4), or can function to remove stages a specified function (e.g., all stages that request a phone number), or can function to remove all stages beyond (greater than or less than) as specified value (e.g., all stages greater than 6, all stages less than 8 and greater than 2).

In one embodiment, a “Remove” operator can function to remove all occurrences of a specified value/function (e.g., all email validation stages) from a collection of stages. In one embodiment, a “Filter” operator can function to create a new collection of stages with only items that match a specified criteria. In one embodiment, a “Map” operator can function to create a new collection of stages where the contents are returned by a mapper (e.g., Collection S Object-> Collection of IDs).

In one embodiment, a “RemoveAt” operator can function to remove items at a specified location (e.g., remove stage 4, remove stage after authentication). In one embodiment, a “Union” operator can function to remove all items that are not specified (e.g., remove all stages not having an associated email address). In one embodiment, a “Sort” operator can function to sort stages according to a specified criteria.

In one embodiment, a “MakeUnique” operator can function to make a collection of stages unique according to a specified order. In one embodiment, a “NotContains” operator can be used search for/modify/edit stages that to not contain a specified value. In one embodiment, a “Size” operator can function to determine a size of the current collection of stages. In one embodiment, an “AddAll” operator can function to add a collection of elements/stages at the end of a collection of stages. Additional and/or different

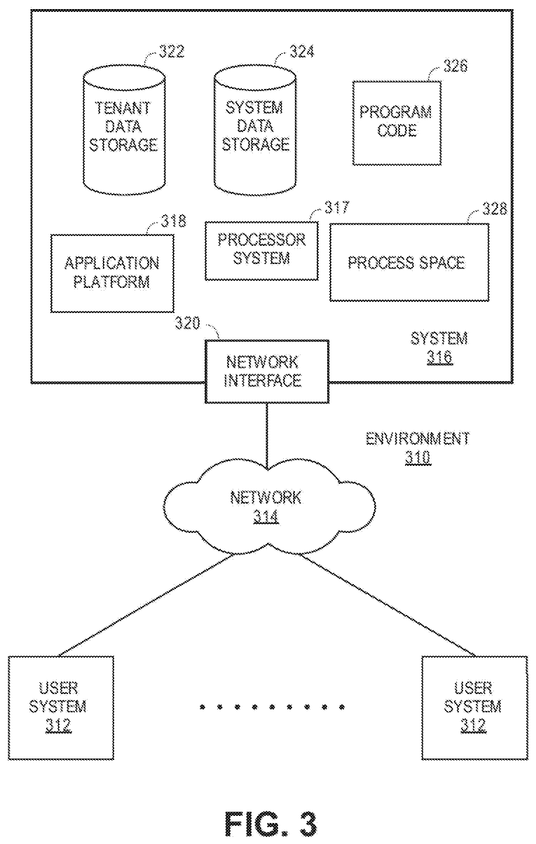

FIG. 3 illustrates a block diagram of an environment 310 wherein an on-demand database service might be used. Environment 310 may include user systems 312, network 314, system 316, processor system 317, application platform 318, network interface 320, tenant data storage 322, system data storage 324, program code 326, and process space 328. In other embodiments, environment 310 may not have all of the components listed and/or may have other elements instead of, or in addition to, those listed above.

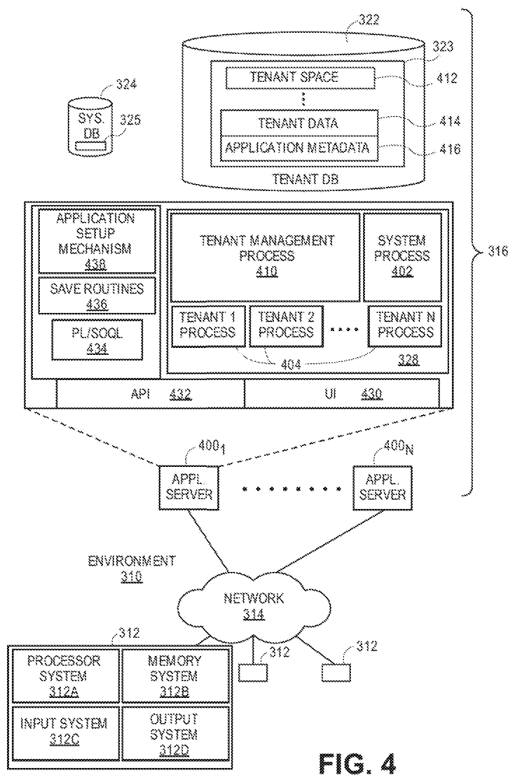

Environment 310 is an environment in which an on-demand database service exists. User system 312 may be any machine or system that is used by a user to access a database user system. For example, any of user systems 312 can be a handheld computing device, a mobile phone, a laptop computer, a work station, and/or a network of computing devices. As illustrated in herein FIG. 3 (and in more detail in FIG. 4) user systems 312 might interact via a network 314 with an on-demand database service, which is system 316.

An on-demand database service, such as system 316, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 316” and “system 316” will be used interchangeably herein. A database image may include one or more database objects. A relational database management system (RDMS) or the equivalent may execute storage and retrieval of information against the database object(s). Application platform 318 may be a framework that allows the applications of system 316 to run, such as the hardware and/or software, e.g., the operating system. In an embodiment, on-demand database service 316 may include an application platform 318 that enables creation, managing and executing one or more applications developed by the provider of the on-demand database service, users accessing the on-demand database service via user systems 312, or third party application developers accessing the on-demand database service via user systems 312.

The users of user systems 312 may differ in their respective capacities, and the capacity of a particular user system 312 might be entirely determined by permissions (permission levels) for the current user. For example, where a salesperson is using a particular user system 312 to interact with system 316, that user system has the capacities allotted to that salesperson. However, while an administrator is using that user system to interact with system 316, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 314 is any network or combination of networks of devices that communicate with one another. For example, network 314 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 312 might communicate with system 316 using TCP/IP and, at a higher network level, use other common Internet protocols to communicate, such as HTTP, FTP, AFS, WAP, etc. In an example where HTTP is used, user system 312 might include an HTTP client commonly referred to as a “browser” for sending and receiving HTTP messages to and from an HTTP server at system 316. Such an HTTP server might be implemented as the sole network interface between system 316 and network 314, but other techniques might be used as well or instead. In some implementations, the interface between system 316 and network 314 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 316, shown in FIG. 3, implements a web-based customer relationship management (CRM) system. For example, in one embodiment, system 316 includes application servers configured to implement and execute CRM software applications as well as provide related data, code, forms, webpages and other information to and from user systems 312 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 316 implements applications other than, or in addition to, a CRM application. For example, system 316 may provide tenant access to multiple hosted (standard and custom) applications, including a CRM application. User (or third party developer) applications, which may or may not include CRM, may be supported by the application platform 318, which manages creation, storage of the applications into one or more database objects and executing of the applications in a virtual machine in the process space of the system 316.

One arrangement for elements of system 316 is shown in FIG. 3, including a network interface 320, application platform 318, tenant data storage 322 for tenant data 323, system data storage 324 for system data 325 accessible to system 316 and possibly multiple tenants, program code 326 for implementing various functions of system 316, and a process space 328 for executing MTS system processes and tenant-specific processes, such as running applications as part of an application hosting service. Additional processes that may execute on system 316 include database indexing processes.

Several elements in the system shown in FIG. 3 include conventional, well-known elements that are explained only briefly here. For example, each user system 312 could include a desktop personal computer, workstation, laptop, PDA, cell phone, or any wireless access protocol (WAP) enabled device or any other computing device capable of interfacing directly or indirectly to the Internet or other network connection. User system 312 typically runs an HTTP client, e.g., a browsing program, such as Edge from Microsoft, Safari from Apple, Chrome from Google, or a WAP-enabled browser in the case of a cell phone, PDA or other wireless device, or the like, allowing a user (e.g., subscriber of the multi-tenant database system) of user system 312 to access, process and view information, pages and applications available to it from system 316 over network 314. Each user system 312 also typically includes one or more user interface devices, such as a keyboard, a mouse, touch pad, touch screen, pen or the like, for interacting with a graphical user interface (GUI) provided by the browser on a display (e.g., a monitor screen, LCD display, etc.) in conjunction with pages, forms, applications and other information provided by system 316 or other systems or servers. For example, the user interface device can be used to access data and applications hosted by system 316, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 312 and all of its components are operator configurable using applications, such as a browser, including computer code run using a central processing unit such as an Intel Core series processor or the like. Similarly, system 316 (and additional instances of an MTS, where more than one is present) and all of their components might be operator configurable using application(s) including computer code to run using a central processing unit such as processor system 317, which may include an Intel Core series processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 316 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 316 is configured to provide webpages, forms, applications, data and media content to user (client) systems 312 to support the access by user systems 312 as tenants of system 316. As such, system 316 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 4 also illustrates environment 310. However, in FIG. 4 elements of system 316 and various interconnections in an embodiment are further illustrated. FIG. 4 shows that user system 312 may include processor system 312A, memory system 312B, input system 312C, and output system 312D. FIG. 4 shows network 314 and system 316. FIG. 4 also shows that system 316 may include tenant data storage 322, tenant data 323, system data storage 324, system data 325, User Interface (UI) 430, Application Program Interface (API) 432, PL/SOQL 434, save routines 436, application setup mechanism 438, applications servers 400₁-400_{N}, system process space 402, tenant process spaces 404, tenant management process space 410, tenant storage area 412, user storage 414, and application metadata 416. In other embodiments, environment 310 may not have the same elements as those listed above and/or may have other elements instead of, or in addition to, those listed above.

User system 312, network 314, system 316, tenant data storage 322, and system data storage 324 were discussed above in FIG. 3. Regarding user system 312, processor system 312A may be any combination of one or more processors. Memory system 312B may be any combination of one or more memory devices, short term, and/or long term memory. Input system 312C may be any combination of input devices, such as one or more keyboards, mice, trackballs, scanners, cameras, and/or interfaces to networks. Output system 312D may be any combination of output devices, such as one or more monitors, printers, and/or interfaces to networks. As shown by FIG. 4, system 316 may include a network interface 320 (of FIG. 3) implemented as a set of HTTP application servers 400, an application platform 318, tenant data storage 322, and system data storage 324. Also shown is system process space 402, including individual tenant process spaces 404 and a tenant management process space 410. Each application server 400 may be configured to tenant data storage 322 and the tenant data 323 therein, and system data storage 324 and the system data 325 therein to serve requests of user systems 312. The tenant data 323 might be divided into individual tenant storage areas 412, which can be either a physical arrangement and/or a logical arrangement of data. Within each tenant storage area 412, user storage 414 and application metadata 416 might be similarly allocated for each user. For example, a copy of a user's most recently used (MRU) items might be stored to user storage 414. Similarly, a copy of MRU items for an entire organization that is a tenant might be stored to tenant storage area 412. A UI 430 provides a user interface and an API 432 provides an application programmer interface to system 316 resident processes to users and/or developers at user systems 312. The tenant data and the system data may be stored in various databases, such as one or more Oracle™ databases.

Application platform 318 includes an application setup mechanism 438 that supports application developers' creation and management of applications, which may be saved as metadata into tenant data storage 322 by save routines 436 for execution by subscribers as one or more tenant process spaces 404 managed by tenant management process 410 for example. Invocations to such applications may be coded using PL/SOQL 434 that provides a programming language style interface extension to API 432. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 416 for the subscriber making the invocation and executing the metadata as an application in a virtual machine.

Each application server 400 may be communicably coupled to database systems, e.g., having access to system data 325 and tenant data 323, via a different network connection. For example, one application server 400₁ might be coupled via the network 314 (e.g., the Internet), another application server 400_{N-1} might be coupled via a direct network link, and another application server 400_{N} might be coupled by yet a different network connection. Transfer Control Protocol and Internet Protocol (TCP/IP) are typical protocols for communicating between application servers 400 and the database system. However, it will be apparent to one skilled in the art that other transport protocols may be used to optimize the system depending on the network interconnect used.

In certain embodiments, each application server 400 is configured to handle requests for any user associated with any organization that is a tenant. Because it is desirable to be able to add and remove application servers from the server pool at any time for any reason, there is preferably no server affinity for a user and/or organization to a specific application server 400. In one embodiment, therefore, an interface system implementing a load balancing function (e.g., an F5 BIG-IP load balancer) is communicably coupled between the application servers 400 and the user systems 312 to distribute requests to the application servers 400. In one embodiment, the load balancer uses a least connections algorithm to route user requests to the application servers 400. Other examples of load balancing algorithms, such as round robin and observed response time, also can be used. For example, in certain embodiments, three consecutive requests from the same user could hit three different application servers 400, and three requests from different users could hit the same application server 400. In this manner, system 316 is multi-tenant, wherein system 316 handles storage of, and access to, different objects, data and applications across disparate users and organizations.

As an example of storage, one tenant might be a company that employs a sales force where each salesperson uses system 316 to manage their sales process. Thus, a user might maintain contact data, leads data, customer follow-up data, performance data, goals and progress data, etc., all applicable to that user's personal sales process (e.g., in tenant data storage 322). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 316 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 316 might also maintain system level data usable by multiple tenants or other data. Such system level data might include industry reports, news, postings, and the like that are sharable among tenants.

In certain embodiments, user systems 312 (which may be client systems) communicate with application servers 400 to request and update system-level and tenant-level data from system 316 that may require sending one or more queries to tenant data storage 322 and/or system data storage 324. System 316 (e.g., an application server 400 in system 316) automatically generates one or more SQL statements (e.g., one or more SQL queries) that are designed to access the desired information. System data storage 324 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

1. A method for processing a sequence of operations, the method comprising:
causing, by a hardware processor in response to a receipt of a first signal, operation tracking screens to be presented on a display, wherein at least some of a first screen area has one or more graphical control elements configured to receive information associated with actions corresponding to the sequence of operations, the actions including at least a first action performed concurrently with a second action, and wherein a second screen area has a graphical representation of stages of the sequence of operations in response to an initiation of the application to process the sequence of operations, and the graphical representation of the stages being modified to include a graphical representation of a modification to the stages, wherein the modification comprises a modification to multiple stages concurrently;
receiving, by the processor, second signals associated with the information associated with the actions associated with the sequence of operations; and
causing, by the processor in response to receipt of the second signals, the sequence of operations to be processed.

2. The method of claim 1, wherein the graphical control elements include at least one of a button, a radio button, a check box, a split button, a cycle button, a slider, a list box, a spinner, a drop-down list, a menu, a context menu, a pie menu, a menu bar, a tool bar, a ribbon, a combo box, or a text box.

3. The method of claim 1, wherein receiving the second signals associated with the information comprises receiving at least one of the second signals associated with the information as a free-form text and causing the sequence of operations to be processed includes producing, through a word embedding process, a vector that represents at least one word of the free-form text.

4. A non-transitory computer-readable medium storing computer code for controlling a processor to cause the processor to process a sequence of operations, the computer code including instructions to cause the processor to:
cause, by a hardware processor in response to a receipt of a first signal, operation tracking screens to be presented on a display, wherein at least some of a first screen area has one or more graphical control elements configured to receive information associated with actions corresponding to the sequence of operations, the actions including at least a first action performed concurrently with a second action, and wherein a second screen area has a graphical representation of stages of the sequence of operations in response to an initiation of the application to process the sequence of operations, and the graphical representation of the stages being modified to include a graphical representation of a modification to the stages, wherein the modification comprises a modification to multiple stages concurrently;
receive, by the processor, second signals associated with the information associated with the actions associated with the sequence of operations; and
cause, by the processor in response to receipt of the second signals, the sequence of operations to be processed.

5. A system for processing a sequence of operations, the system comprising:
a database; and
a processor configured to:
receive a first signal to initiate an application to process the sequence of operations;
cause, by a hardware processor in response to a receipt of a first signal, operation tracking screens to be presented on a display, wherein at least some of a first screen area has one or more graphical control elements configured to receive information associated with actions corresponding to the sequence of operations, the actions including at least a first action performed concurrently with a second action, and wherein a second screen area has a graphical representation of stages of the sequence of operations in response to an initiation of the application to process the sequence of operations, and the graphical representation of the stages being modified to include a graphical representation of a modification to the stages, wherein the modification comprises a modification to multiple stages concurrently;
receive, by the processor, second signals associated with the information associated with the actions associated with the sequence of operations; and
cause, by the processor in response to receipt of the second signals, the sequence of operations to be processed.

6. A method for producing a first application to process a first
sequence of operations, the method comprising:
receiving, by a processor, a first signal to initiate a production of the first application to process the first sequence of operations;
causing, by the processor in response to a receipt of the first signal, an operation tracking design screen to be presented on a first display,
wherein the operation tracking design screen includes a first screen area and a second screen area,
wherein the first screen area is a canvas graphical user interface, and
wherein the second screen area includes a population of first graphical control elements configured to cause, in response to being selected, first graphical representations to appear in the first screen area;
receiving, by the processor, second signals that indicate:
selections, from the population, of a set of first graphical control elements, the set of first graphical control elements being associated with actions associated with the first sequence of operations, and
directions, with respect to a set of first graphical representations, among the actions associated with the first sequence of operations; and
causing, by the processor in response to receipts of the second signals, a first set of operation tracking screens to be produced,
wherein at least some of the operation tracking screens include third screen areas and fourth screen areas,
wherein at least some of the third screen areas have second graphic control elements configured to receive information associated with the actions associated with the first sequence of operations, the actions including a first action performed concurrently with a second action, and
wherein the fourth screen areas have a graphical representation of stages of the first sequence of operations,
the graphical representation of the stages being of a default sequence of the stages in response to an initiation of the first application to process the first sequence of operations, and
the graphical representation of the stages being modified to include a graphical representation of an additional stage in response to a determination of a result of a specific condition being a specific value.

7. The method of claim 6, wherein:
the second signals include first second signals and second second signals, the first second signals indicate the selections of the set of first graphical control elements,
the second second signals indicate the directions, with respect to the set of first graphical representations, among the actions associated with the first sequence of operations, and
the causing the operation tracking screens to be produced comprises:
causing, by the processor in response to receipts of the first second signals, a set of the first graphical representations, associated with the set of first graphical control elements, to appear in the first screen area, and
causing, by the processor in response to receipts of the second second signals, a set of second graphical representations to appear in the first screen area, wherein the set of second graphical representations indicate the directions, with respect to the set of first graphical representations, among the actions associated with the first sequence of operations.

8. The method of claim 7, wherein the causing the set of second graphical
representations to appear in the first screen area comprises:
causing a graphical representation, of the set of second graphical representations, to appear in the first screen area at a location of a first graphical representation of the set of first graphical representations; and
causing a pointing device gesture to occur to move the graphical representation to appear in the first screen area at a location of a second graphical representation of the set of first graphical representations.

9. The method of claim 7, wherein the actions associated with the first sequence of operations further include:
third actions causing the stages of the first sequence of operations to be defined;
fourth actions causing the operation tracking screens to be presented on a second display; and
a fifth action being determining the result of the specific condition.

10. The method of claim 9, wherein the second display is the first display.

11. The method of claim 6, wherein the second signals:
indicate first selections of a first type of the first graphical control elements, the first type being associated with an action to change a value of a specific variable, the specific variable referenceable by another action,
select the specific variable to be a stage, the stage being of the first sequence of operations,
set the value to be a name of the stage,
indicate second selections of a second type of the first graphical control elements, the second type being associated with an action to present an operation tracking screen, indicate a third selection of a third type of the first graphical control elements, the third type being associated with an action to determine a result of a condition, and set the condition to be the specific condition.

12. The method of claim 6, wherein the set of first graphical control elements includes a type of the first graphical control elements associated with an action to change a value of a specific variable, the specific variable referenceable by another action.

13. The method of claim 12, wherein:
the second screen area includes a tab interface, a first tab of the tab interface including the population of first graphical control elements, a second tab of the tab interface including a set of variables, the variables referenceable by other actions, the second signals select, from the set of variables, the specific variable, and the second signals set the value of the specific variable.

14. The method of claim 6, wherein the set of first graphical control elements includes a type of the first graphical control elements associated with an action to initiate a second application to process a second sequence of operations.

15. The method of claim 14, wherein the second sequence of operations is associated with a second set of operation tracking screens.

16. The method of claim 14, wherein actions associated with the second sequence of operations include an action to interface with the database.

17. The method of claim 6, wherein the actions associated with the first sequence of operations further include at least one of:
an action causing a value to be read from the database,
an action causing a value to be written to the database,
an action causing a record to be created in the database,
an action causing a record to be deleted from the database,
an action determining a result of a condition,
an action causing at least one specific action to be performed, in an iterative manner, on each item in a set of items, or
an action causing processing of at least a portion of the first sequence of operations to pause until a specific event occurs.

18. The method of claim 17, wherein the set of first graphical control elements includes at least one of:
a type of the first graphical control elements associated with the action causing the value to be read from the database,
a type of the first graphical control elements associated with the action causing the value to be written to the database,
a type of the first graphical control elements associated with the action causing the record to be created in the database,
a type of the first graphical control elements associated with the action causing the record to be deleted from the database,
a type of the first graphical control elements associated with the action determining the result of the condition,
a type of first graphical control elements associated with the action causing the at least one specific action to be performed, in the iterative manner, on the each item in the set of items, or
a type of the first graphical control elements associated with the action causing processing of the at least the portion of the first sequence of operations to pause until the specific event occurs.

19. A non-transitory computer-readable medium storing computer code for controlling a processor to cause the processor to produce an application to process a sequence of operations, the computer code including instructions to cause the processor to:
receive a first signal to initiate a production of the application to process the sequence of operations;
cause, in response to a receipt of the first signal, an operation tracking design screen to be presented on a first display,
wherein the operation tracking design screen includes a first screen area and a second screen area,
wherein the first screen area is a canvas graphical user interface, and
wherein the second screen area includes a population of first graphical control elements configured to cause, in response to being selected, first graphical representations to appear in the first screen area;
receive second signals that indicate:
selections, from the population, of a set of first graphical control elements, the set of first graphical control elements being associated with actions associated with the sequence of operations, and
directions, with respect to a set of first graphical representations, among the actions associated with the sequence of operations; and
cause, in response to receipts of the second signals, a set of operation tracking screens to be produced,
wherein at least some of the operation tracking screens include third screen areas and fourth screen areas,
wherein at least some of the third screen areas have second graphic control elements configured to receive information associated with the actions associated with the sequence of operations, the actions including a first action performed concurrently with a second action, and
wherein the fourth screen areas have a graphical representation of stages of the sequence of operations,
the graphical representation of the stages being of a default sequence of the stages in response to an initiation of the application to process the sequence of operations, and the graphical representation of the stages being modified to include a graphical representation of an additional stage in response to a determination of a result of a specific condition being a specific value.

20. A system for producing an application to process a sequence of operations, the system comprising:
a database; and
a processor configured to:
receive a first signal to initiate a production of the application to process the sequence of operations;
cause, in response to a receipt of the first signal, an operation tracking design screen to be presented on a first display,
wherein the operation tracking design screen includes a first screen area and a second screen area,
wherein the first screen area is a canvas graphical user interface, and
wherein the second screen area includes a population of first graphical control elements configured to cause, in response to being selected, first graphical representations to appear in the first screen area;
receive second signals that indicate:
selections, from the population, of a set of first graphical control elements, the set of first graphical control elements being associated with actions associated with the sequence of operations, and
directions, with respect to a set of first graphical representations, among the actions associated with the sequence of operations; and
cause, in response to receipts of the second signals, a set of operation tracking screens to be produced,
wherein at least some of the operation tracking screens include third screen areas and fourth screen areas,
wherein at least some of the third screen areas have second graphic control elements configured to receive information associated with the actions associated with the sequence of operations, the actions including a first action performed concurrently with a second action, and
wherein the fourth screen areas have a graphical representation of stages of the sequence of operations,
the graphical representation of the stages being of a default sequence of the stages in response to an initiation of the application to process the sequence of operations, and
the graphical representation of the stages being modified to include a graphical representation of an additional stage in response to a determination of a result of a specific condition being a specific value.
